(19) United States
(12) Patent Application Publication
(10) Pub. No.: US 2023/0332804 A1
(43) Pub. Date: Oct. 19, 2023

(54) APPARATUS AND METHOD FOR THERMAL FOUNDATION ELEMENTS

(71) Applicant: CAPTURE TECHNOLOGIES CORPORATION, Hamilton (CA)

(72) Inventors: Seyed Masih Alavy GHAHFARROKHY, North York (CA); Ladislav RAK, Caledon (CA); Jun WANG, North York (CA); David Ernest SALT, Stoney Creek (CA); Afroozalsadat ALAVI, Toronto (CA); Jaroslava Marie-Magdalena PARSLOW, Caledon (CA); Seth B. DWORKIN, Toronto (CA); Ayman Mahmoud Bayomy MAHMOUD, Petawawa (CA); Aggrey MWEISGYE, North York (CA); Hiep V. NGUYEN, Toronto (CA)

(21) Appl. No.: 18/025,787

(22) PCT Filed: Sep. 14, 2021
(86) PCT No.: PCT/CA2021/051283

§ 371 Date: Mar. 10, 2023

Related U.S. Application Data
(60) Provisional application No. 63/078,308, filed on Sep. 14, 2020.
(60) Provisional application No. 63/177,169, filed on Apr. 20, 2021.

(51) Int. Cl. F24T 10/15; F24T 50/00

(52) U.S. Cl. CPC F24T 10/15; F24T 50/00; F24T 2201/00

(57) ABSTRACT

A building heating and cooling system includes a structural foundation member that extends into a borehole. A heat exchange loop is installed within the foundation member for heat exchange with ground surrounding the foundation member. The heat exchange hoop is interconnected with a heat pump for providing heating or cooling to the building by heat exchange with ground surrounding the foundation member.

### RELATED APPLICATIONS

This claims priority from U.S. provisional patent application No. 63/078,308, filed Sep. 14, 2020, and U.S. provisional patent application No. 63/177,169, filed Apr. 20, 2021, the entire contents of which are incorporated herein by reference.

### FIELD

This relates to building heating and cooling systems, and in particular to thermal foundation elements for ground-source heating and cooling.

### BACKGROUND

Traditional geothermal heating and cooling systems have been in use for decades. However, over time, such systems have commonly been found to be deficient. For example, traditional geothermal heating systems are very expensive to install. Moreover, performance and efficiency of many traditional systems declines over time.

### SUMMARY

An example system for heating and cooling a building comprises: a structural foundation member extending into a borehole; a heat exchange loop within the foundation member and interconnected with a heat pump for providing heating or cooling to the building by heat exchange with ground surrounding the foundation member.

An example method of installing a ground-source heat exchange loop in thermal communication with a heat pump of a building, the method comprising: boring a hole in ground for receiving a structural foundation member; placing a ground-source heat exchange loop within the hole.

An example thermal design system comprises: a finite-volume model of a below-ground foundation structure of a building with a heat exchange loop therein; a thermal requirements model defining heating and cooling requirements of a building in discrete time steps over a one-year period; a simulator configured to compute ground temperatures according to said thermal model based on said heating and cooling requirements; a thermal reservoir unit, configured to define a phase change reservoir for installation in a below-ground foundation structure, wherein defining a phase change reservoir comprises defining a phase change temperature based on a ground temperature corresponding to a transition between heating and cooling requirements in said model.

### BRIEF DESCRIPTION OF DRAWINGS

In The figures, which depict example embodiments:

FIG. 1 is a schematic diagram of a building heating and cooling system;

FIG. 2 is a schematic diagram of another building heating and cooling system including a thermal caisson;

FIGS. 3A-3B are isometric and transverse cross-sectional views, respectively of a thermal caisson;

FIGS. 3C-3D are isometric and top views of a coupling;

FIG. 4 is a transverse cross-sectional view of another thermal caisson;

FIG. 5 is a transverse cross-sectional view of another thermal caisson;

FIG. 6 is a transverse cross-sectional view of another thermal caisson;

FIG. 7 is a transverse cross-sectional view of another thermal caisson;

FIG. 8 is a block diagram of a computing device;

FIG. 9 is a block diagram showing components at the computing device of FIG. 8;

FIG. 10 is a plot of building thermal loads over a one-year period, in discrete time steps;

FIG. 11 is a representation of a material properties model;

FIG. 12 is a plot of ambient air temperatures over a one-year period, in discrete time steps;

FIG. 13 is a flow chart showing a process of installing a thermal caisson;

FIG. 14 is a flow chart showing a simulation process;

FIG. 15 is a plot of temperature values over a simulated one-year period; and

FIGS. 16A-16C are schematic views showing stages of installation of a thermal caisson; and

FIG. 17 is a plot of ground temperatures proximate a heat exchange loop.

### DETAILED DESCRIPTION

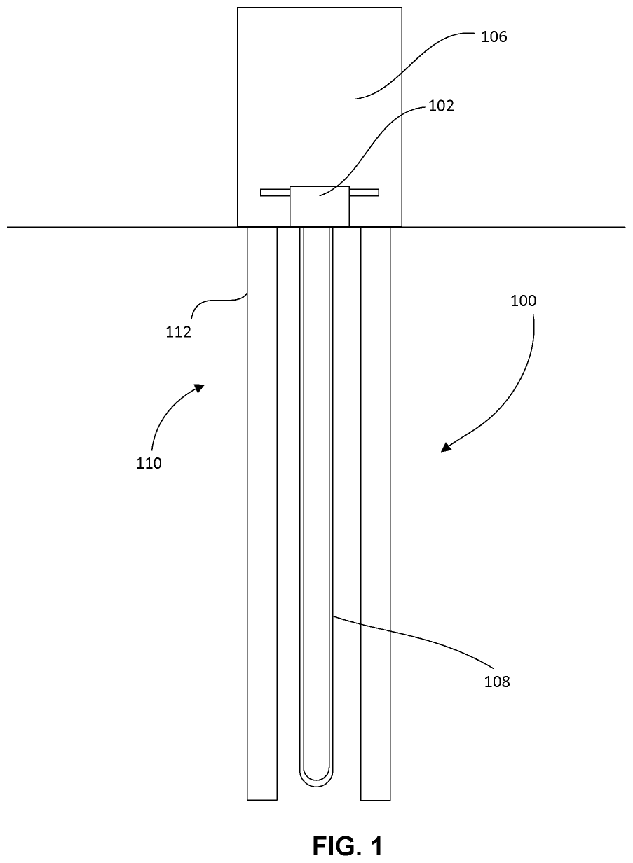

FIG. 1 depicts an example building heating and cooling system 100. Heating and cooling system 100 includes a heat pump 102. Heat pump 102 is operable to transfer heat between a thermal reservoir 104 and the interior of a building 106. Heat pump 102 is a ground source heat pump. That is, heat pump 102 is in thermal contact with the ground by way of a ground heat exchange loop 108.

As shown, heat pump 102 is used to provide a supply of heated or cooled air for heating, ventilation and air conditioning of building 106. In a cooling mode, heat pump 102 receives heat from building 106 and rejects heat to ground by way of ground heat exchange loop 108. In a heating mode, heat pump 102 receives heat from ground by way of ground heat exchange loop 108 and rejects heat to building 106.

As will be apparent, although heat pump 102 is used for heating or cooling of air in building 106, other applications are possible. For example, heat pump 102 could be used to heat or cool water for use in building 106, or could be used to provide heating or refrigeration for industrial processes.

Building 106 has a foundation 110 with structural members such as pilings 112 extending into ground below building 106. Pilings 112 may be caissons, or any other type of structural members suitable for the design of building 106 and characteristics of the ground on which building 106 is constructed.

Pilings 112 are constructed by boring holes extending into the ground, and forming concrete supports in the holes. Depending on design pilings 112 may include reinforcements such as rebar, casings or the like.

Ground heat exchange loop 108 is constructed by boring holes in the ground. Conduits are installed in the holes, and a working fluid is flowed in a loop through the conduits and through a heat exchanger in heat pump 102.

Heating and cooling requirements of building 106 are influenced by weather conditions. In many climates, such as temperate climates, heat and cold may be required at alternate portions of the year (referred to as heating and cooling seasons, respectively). During the heating season, system 100 transfers heat away from ground and into building 106. During the cooling season, system 100 transfers heat away from building 106 and into ground.

Performance of system 100 may be described in terms of coefficient of performance (COP), namely the ratio of useful heat produced (or extracted) in building 106 to the energy used to drive heat pump 102. COP is influenced by the temperature difference between ground and building

For some buildings, total annual heating and cooling requirements may not balance. For example, based on features such as climate or type of building use, the portion of the year during which cooling is required may be greater than the portion of the year during which heating is required, or vice versa. Additionally or alternatively, heating and cooling intensities may not be balanced.

Imbalances of heating and cooling requirements correspond to imbalances of heat extracted from and rejected to ground, respectively. Over time, such imbalances can alter ground temperatures in the vicinity of ground heat exchange loop 108, which can, in turn, reduce the coefficient of performance of the heating and cooling system.

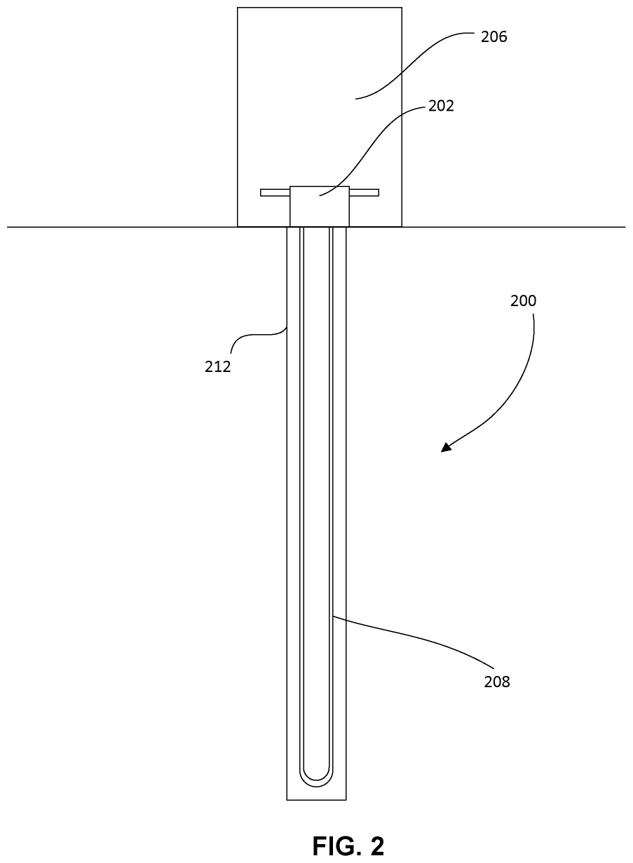

FIG. 2 depicts another heating and cooling system 200 for cooling a building 206. Heating and cooling system 200 includes a heat pump 202, substantially identical to that of heating and cooling system 100. Heat pump 202 is connected with a ground heat exchange loop 208.

Ground heat exchange loop 208 is installed in structural foundation members of building 206. Specifically, as depicted, ground heat exchange loop 208 forms part of thermal caissons 212. As will be apparent, the presently disclosed apparatus and methods are not limited to caissons, and may be integrated with other types of foundation structures. Integration of heat exchange loop 208 in thermal caissons 212 permits installation costs to be reduced, relative to traditional ground-source heat pump systems in which dedicated holes are bored to receive heat exchange loops.

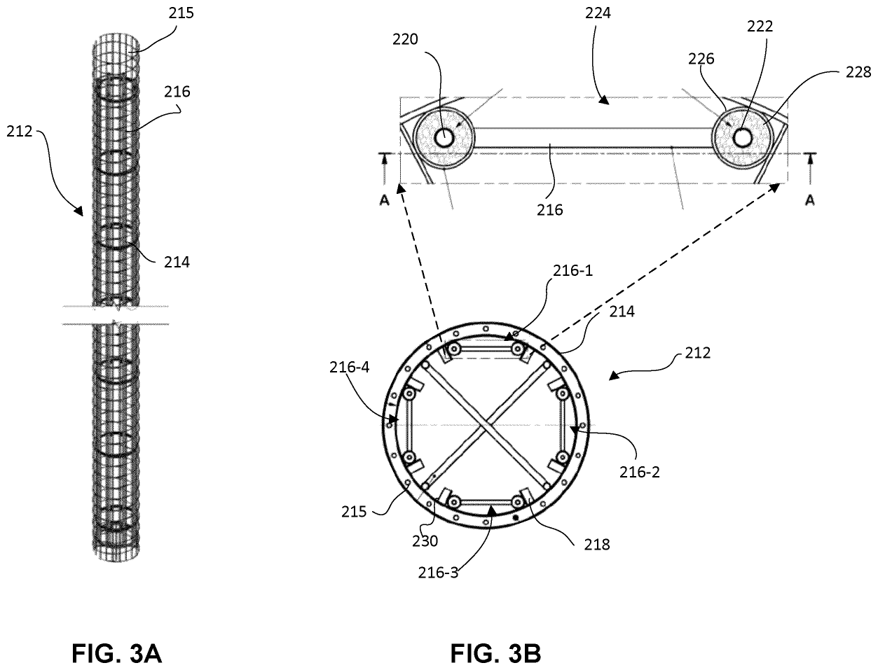

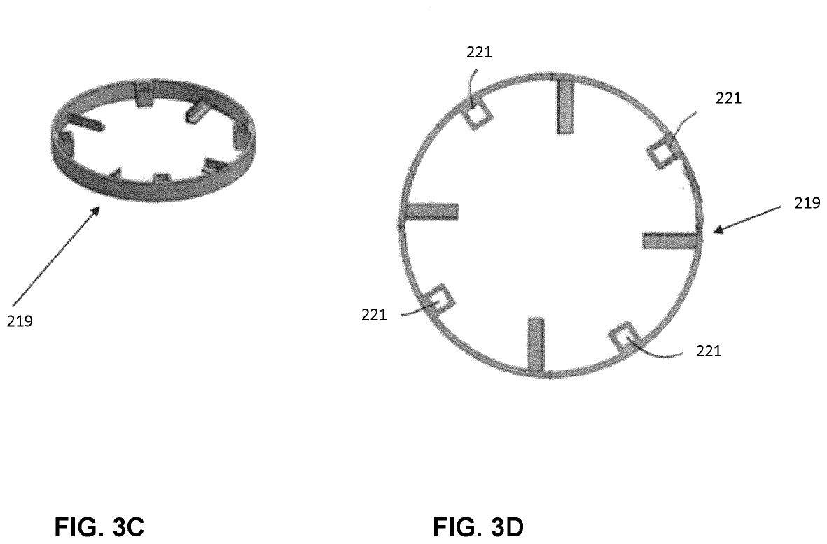

FIGS. 3A and 3B respectively depict a perspective view and a transverse cross-section of thermal caisson 212. The transverse cross-section of FIG. 3B is taken along line B-B shown in FIG. 3A.

As shown, each thermal caisson 212 includes a casing 214. A reinforcing rebar cage 215 is positioned concentrically within casing 214. Ground heat exchange loop 208 includes fluid conduits 216-1, 216-2, 216-3, 216-4 (individually and collectively, fluid conduits 216). Although four fluid conduits 216 are depicted, any number of conduits may be present, subject to space constraints and the peak heating and cooling rate required.

Fluid conduits 216 may be mounted to casing 214 using brackets 218. Each fluid conduit 216 is formed in a loop with parallel legs 220, 222. A working fluid is contained within each fluid conduit 216 and flows in a circuit. In a cooling mode, the fluid passes through heat pump 102 (FIG. 1), downwardly through the leg 220 of a fluid conduit 216, then upwardly through leg 222 of the fluid conduit 216. In such a mode, the working fluid absorbs heat from building 106 in heat pump 102. The working fluid cools as it flows down leg 220 and rejects heat to the surroundings, e.g. the ground. The working fluid further cools as it flows up leg 222 and back to the heat pump. A temperature gradient forms in the working fluid along the length of fluid conduit 216. Fluid temperature generally decreases along the length of fluid conduit 216 as heat is transferred away from the working fluid, such that fluid temperature is generally lower when the working fluid is flowing upwardly in leg 220 than when it is flowing downwardly in leg 222.

Thermal caisson 212 may be assembled in axially-extending sections, with couplings between sections. FIGS. 3C and 3D respectively depict isometric and top views of an example coupling 219. Coupling 219 includes a ring which may be coupled to casing 214 and rebar cage 215, e.g. by welding or using fasteners. Coupling 219 may also include guides 221 projecting radially inwardly from the ring, and including apertures to receive fluid conduits 216 or brackets 218.

In a heating mode, working fluid passes through heat pump 102 (FIG. 1) and rejects heat to building 106, which cools the working fluid. The working fluid then flows through leg 220, absorbing heat from the surroundings. Working fluid then flows upwardly through leg 222 and back to the heat pump 102. A temperature gradient is defined along the length of conduit 216. Fluid temperature generally increases along the length of conduit 216 as heat is absorbed by the working fluid, such that the temperature of downwardly-flowing working fluid in leg 220 is warmer than that of upwardly-flowing working fluid in leg 222.

As noted, a plurality of fluid conduits 216 may be present. Working fluid may flow in parallel through the conduits. For example, each conduit 216 may communicate with a different heat exchanger or portion of a heat exchanger in heat pump 102, or conduits 216 may receive working fluid from and supply working fluid to manifolds on a single heat exchanger.

Thermal caisson 212 further includes a thermal buffer in thermal communication with fluid conduits 216. The thermal buffer comprises a mixture of a phase change material designed to change states (liquefy) when receiving heat from working fluid in conduits 216 and to change states (solidify) when rejecting heat to working fluid in conduits 216, with one or more additives to improve thermal conductivity. Suitable phase change materials may include water insoluble organic low temperature materials derived from petroleum, plants, plant-based feedstocks, or animals, including hydrocarbons, paraffins (CₙH₂ₙ₊₂), lipids, sugar alcohol and combinations thereof. For example, suitable phase change materials may include CrodaTherm™ 6.5 PlusICE™, Organic PCM, A2, A3, A4, A5, A6, A6.5 and RT2 HC, RT 3HC_1, RT4, RT 5, RT 5 HC and PCM RT Series organic PCM from Rubitherm Technologies GmbH of Germany. Suitable additives may include, for example, sand. In some embodiments, the thermal buffer material may include multiple different phase change materials that change states at different temperatures.

The thermal buffer adds thermal capacity to each thermal caisson 212. Such added thermal capacity can moderate temperature change in ground surrounding the thermal caisson due to heat transfer to and from working fluid in conduits 216. That is, in a cooling mode of system 100, at least some of the heat transferred out of the working fluid in fluid conduits 216 is transferred to the phase change material in the thermal buffer. The phase change material may absorb this heat by changing from a solid to a liquid phase, with little or no change in average temperature. Likewise, temperature change in ground surrounding thermal caisson 212 would be smaller, relative to a case in which the same amount of heat was transferred in the absence of the phase change material.

Similarly, in a heating mode of system 100, at least some of the heat absorbed by working fluid in fluid conduits 216 may be from the phase change material. The phase change material may liquefy with relatively little change in mean temperature, releasing heat to working fluid in fluid conduits 216. The temperature change in ground surrounding caisson 212 would be smaller, relative to a case in which the same amount of heat was absorbed in the absence of phase change material.

In the depicted embodiment, fluid conduits 216 form part of a thermal assembly 224 within thermal caisson 212. Specifically, as shown, a jacket 226 is positioned concentrically around each leg 220, 222 of each fluid conduit 216. Thermal buffer 228 is contained in an annular space defined between the fluid conduit 216 and the jacket 226.

Caisson 212 shown in FIG. 2B includes four thermal assemblies, namely, four fluid conduits 216, each with a jacket 226 positioned around legs 220, 222, and phase change material positioned between the conduit and the jacket. Each thermal assembly 224 is mounted to caisson 212 using brackets 230.

In the depicted configuration, thermal buffer 228 acts as a thermal barrier between fluid conduits 216 and other parts of caisson 212 and the surrounding ground. Thus, heat will generally be transferred between fluid conduits 216 and the surrounding ground by way of thermal buffer 228. Thus, heat transfer to or from the surrounding ground may be relatively small until phase change material in thermal buffer 228 has completely changed phases and has changed temperatures such that a substantial temperature difference exists between thermal buffer 228 and ground.

In addition, a portion of thermal buffer 228 is interposed between the legs 220, 222 of each fluid conduit 216. That is, some of the thermal buffer 228 within jacket 226 lies between leg 220 and leg 222 of each fluid conduit 216. Thus, thermal buffer 228 also serves as a thermal barrier between the legs 220, 222. This contributes to efficiency of system 100, as heat exchange between the hot and cold legs 220, 222 tends to moderate temperatures and decrease efficiency of heat transfer into or out of working fluid in fluid conduits 216.

Working fluid within fluid conduits 216 may be a mixture of water with a suitable anti-freeze additive such as ethylene glycol or propylene glycol. The antifreeze additive and the proportion of water and additive are selected based on expected temperature ranges in the vicinity of system 100. Specifically, antifreeze additive may be added in sufficient proportion to prevent freezing in conduit 216 in the temperature ranges the conduit is expected to experience.

Phase change material within thermal buffer 228 is selected based on a desired melting temperature, as will be described in greater detail.

Space within thermal caisson 212 is occupied by concrete. Concrete may be poured into casing 214 subsequent to installation of thermal assemblies 224, such that the concrete envelops the thermal assemblies and occupies substantially all space between casing 214 and the thermal.

In some embodiments, the concrete used may be designed for thermal performance. For example, the concrete density and composition may be designed to promote thermal conductivity, so that heat can be efficiently transferred to and from the surrounding ground. The concrete mix may for example include metallic constituents such as magnetite aggregate or steel powder, or other constituents with high thermal conductivity.

In the example of FIGS. 3A-3D, each thermal assembly 224 is mounted proximate casing 214 of caisson 212, such that the legs 220, 222 substantially span a chord of the circle defined by the cross-section of casing 214.

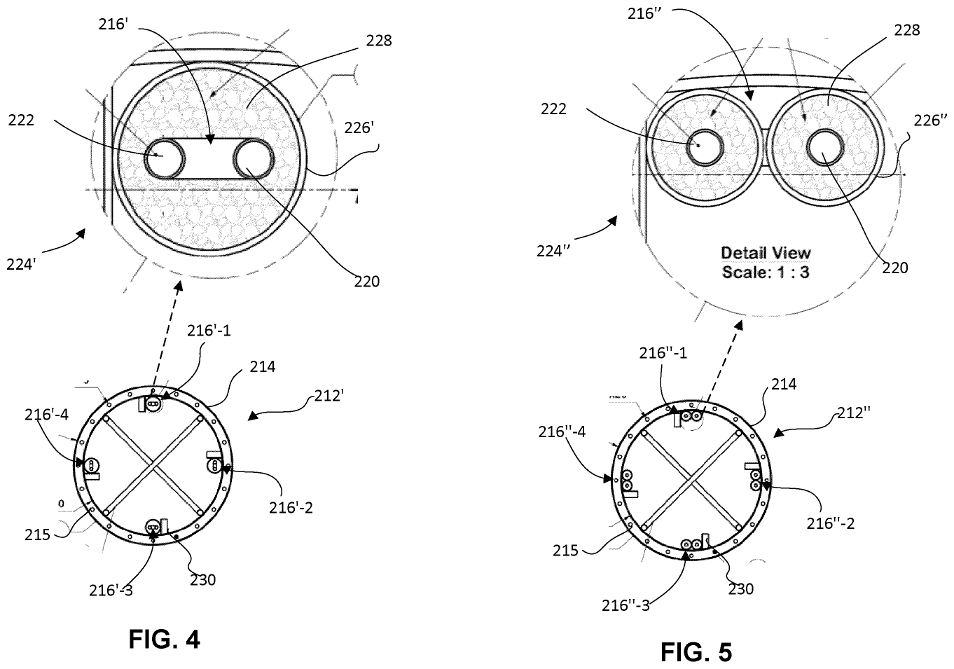

Other spatial configurations and mounting arrangements are possible. For example, FIGS. 4, 5 and 6 depict alternate thermal caissons 212′, 212″, and 212′″, respectively. Thermal caissons 212′, 212″, 212′″ are similar to thermal caisson 212 and like components are indicated with like numerals.

Thermal caisson 212′ has thermal assemblies 224′. Four thermal assemblies 224′ are shown, however, more or fewer may be present, subject to heating or cooling requirements and space constraints.

Each thermal assembly 224′ includes a fluid conduit 216′. A jacket 226′ is positioned around fluid conduit 216′, such that both legs 220, 222 of the fluid conduit 216′ are enclosed in the same space. Thermal buffer 228 is received within jacket 226′ and occupies space between the jacket 226′ and the fluid conduit 216′. Thermal buffer material 228 acts as a thermal barrier between fluid conduit 216′ and the remainder of thermal caisson 212′ and the surrounding ground.

Relative to fluid conduits 216, the hot and cold legs 220, 222 of fluid conduit 216′ are positioned closer to one another and do not have thermal buffer 228 positioned between the legs.

Thermal caisson 212″, shown in FIG. 5 exemplifies another possible configuration. As shown, thermal caisson 212″ has thermal assemblies 224″. Four thermal assemblies 224″ are shown, however, more or fewer may be present based on heating and cooling requirements and space constraints.

Fluid conduits 216″ in thermal assemblies 224″ have jackets 226″ around each of leg 220 and leg 222, with thermal buffer 228 received in the space between the jacket 226″ and the respective leg of the conduit. Legs 220, 222 are positioned close to one another such that their respective jackets abut one another or are spaced a small distance apart. Thermal buffer 228 inside jackets 226 serves as a thermal barrier between the hot and cold legs of conduit 216″ and between conduit 216″ and the remainder of thermal caisson 212″ and the surrounding ground.

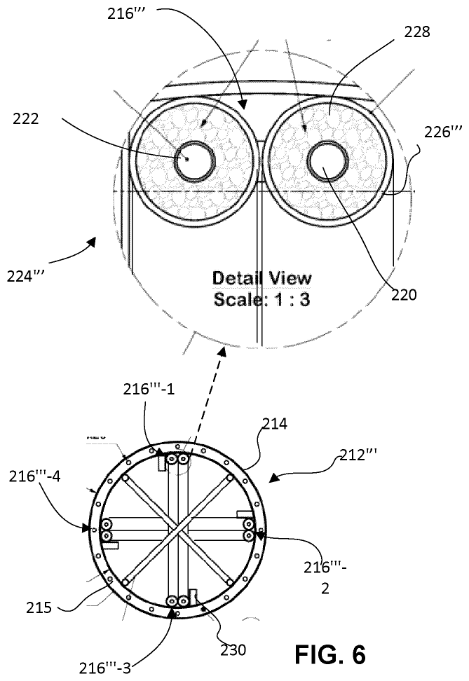

Thermal caisson 212′″, shown in FIG. 6, exemplifies another possible configuration. As shown, thermal caisson 212′″ has thermal assemblies 224′″. Four thermal assemblies 224′″ are shown, however, more or fewer may be present based on heating and cooling requirements and space constraints.

Thermal assemblies 224′″ have fluid conduits 216′″ defining loops that span substantially across an inner diameter of casing 214. That is, each loop has a leg 220 positioned against the inside of casing 214 and a leg 222 positioned against the inside of casing 214, diametrically opposed to the hot leg. In the depicted example, the four thermal assemblies 224′″ are arranged in pairs. That is, the legs 220 of two thermal assemblies 224′″ are positioned adjacent one another at the 12 o'clock position (0°) of casing 214, with the corresponding legs 222 adjacent one another at the 6 o'clock position (180°). Likewise, another pair is positioned with legs 220 at the 3 o'clock position (90°) and legs 222 at the 9 o'clock position (270°).

Each of thermal caissons 212, 212′, 212″, 212′″ includes thermal assemblies with fluid conduits 216, 216′, 216″, 216′″ and jackets which hold a thermal buffer comprising phase change material in thermal and physical contact with the fluid conduits. In other embodiments, a thermal buffer may be provided in a separate vessel or conduit spaced apart from the fluid conduits, rather than in a jacket positioned around the fluid conduits. In such configurations, the fluid conduits and thermal buffers may thermally communicate with one another, without being in physical contact.

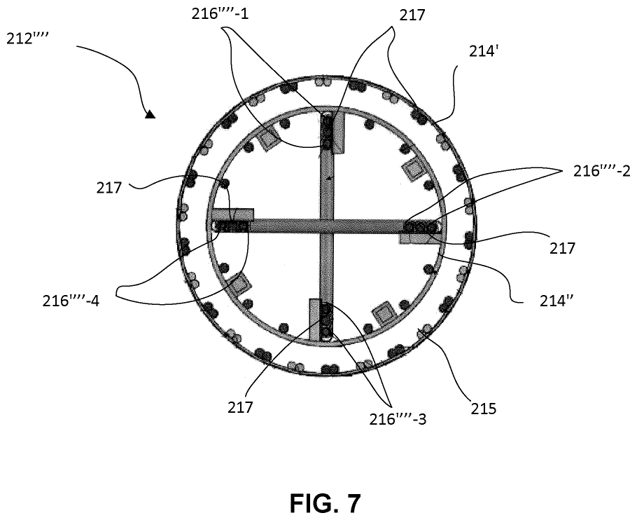

FIG. 7 depicts a thermal caisson 212″″ exemplary of such an embodiment. Thermal caisson 212″″ has an outer casing 214′ and an inner casing 214″ and a plurality of rebar members forming a rebar cage 215′. Fluid conduits 216″″ extend within inner casing 214″ and are supported by a support frame 213. Each fluid conduit 216″″ is formed into a U-loop. In the depicted embodiments, four fluid conduits 216″″-1, 216″″-2, 216″″-3, 216″″-4 are shown. However, more or fewer fluid conduits may be present.

Thermal caisson 212“ ” has a thermal buffer provided in a plurality of phase change material vessels 217. In the depicted embodiment, vessels 217 are pipes, such as steel or high-density polyethylene (HDPE) pipes, filled with a phase change material and capped at both ends. A vessel 217 is positioned between the legs of each fluid conduit 216″″-1, 216″″-2, 216″″-3, 216″″-4. Additional vessels 217 are mounted to each of outer casing 214′ and inner casing 214″.

In an example, caisson 212″″ may be approximately 1.25 m in diameter and 20 m in depth, and may include 13 vessels 217 filled with phase change material mounted to outer casing 214′ and an additional 16 vessels 217 mounted to inner casing 214″. The vessels 217 may be 1¼″ diameter steel pipes, filled with approximately 445 L of CrodaTherm™ 6.5 phase change material or a paraffin wax phase change material, with a melting temperature between 5 and 7° C. The fluid conduits 216′″ may be 1¼″ ID HDPE3608 pipe with total length of 55 feet.

The number, size and depth of caissons within system 100 may be defined based on structural requirements for supporting building 106. The inventors have discovered that the optimal thermal configuration of the caissons, e.g. the number, dimensions and configuration of fluid conduits within the caissons, and the size, composition and configuration of thermal buffers, depends on building and environmental parameters. For example, the thermal configuration may be defined based on thermal (heating and cooling) requirements of building 106 and seasonal variation thereof, as well as characteristics of the surrounding ground (e.g. soil type, density, thermal conductivity, heat capacity) and seasonal climate patterns. In particular, performance can be impacted by the relationship between phase change temperature of the phase change material within the thermal buffer.

Ground source heating and cooling system 100 may be configured and constructed with the aid of computer-implemented tools. In particular, such configuration and construction may be performed using a computer simulation tool to model thermal conditions over time.

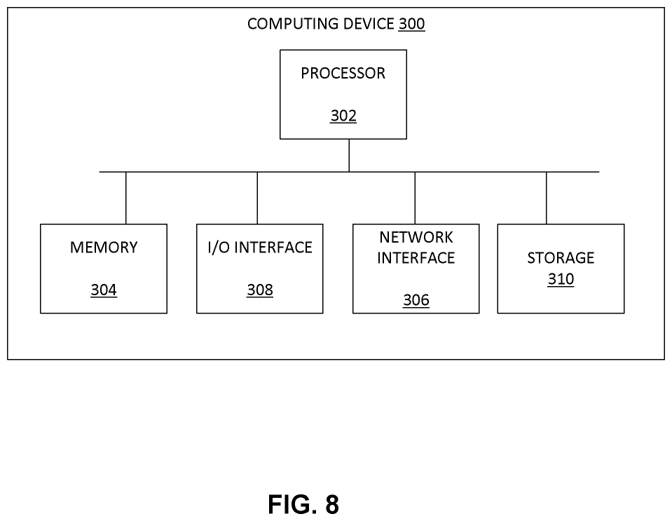

FIG. 8 depicts an example computing device 300 for configuration of a ground source heating and cooling system as disclosed herein.

The computing device 300 includes a processor 302, working memory 304 (RAM), network interface 306, I/O interface 308 and persistent storage 310. Processor 302 may be an Intel x86, PowerPC, ARM processor or the like. Network interface 306 interconnects server 200 to a network (not shown). Computing device 300 may include input and output peripherals interconnected at I/O interface 308. These peripherals may include a keyboard, display, mouse and one or more devices such as DVD drives, USB ports and the like for reading computer-readable storage media.

Computing device 300 is operable under control of software to perform functions as described herein. Such software includes operating system software, such as Microsoft™ Windows™, Apple OSX, Linux or the like, and application software. Software components exemplary of embodiments of the present invention may be stored at persistent storage 310 and loaded into memory 304.

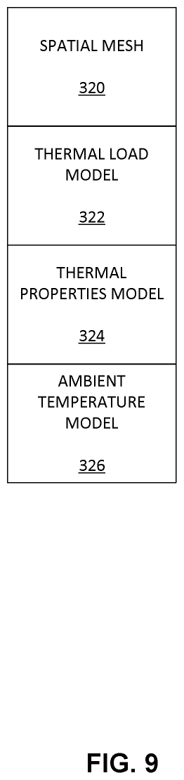

FIG. 9 depicts example components at computing device 300 for simulating thermal conditions over time. Such components include a spatial mesh 320, thermal load model 322, thermal properties model 324 and ambient temperatures model 326. Simulation is performed using finite-volume computational fluid dynamics (CFD) methods, for example, as implemented in ANSYS Fluent™ 18.0.

Spatial mesh 320 represents geometric features of one or more thermal caissons 212 and surrounding ground. Spatial mesh 320 defines a plurality of discrete cells within the modeled region for computation of mass, thermal and momentum balances. Spatial mesh 320 may be automatically defined by computing device 300, e.g. according to a meshing algorithm such as that included as part of ANSYS Fluent™ 18.0. Additionally or alternatively, spatial mesh may be at least partly manually defined. As will be apparent, the quality of spatial mesh 320 may influence the accuracy of simulation using the mesh. Generally, smaller cells and larger numbers of cells are associated with improved accuracy, but increase computational intensity.

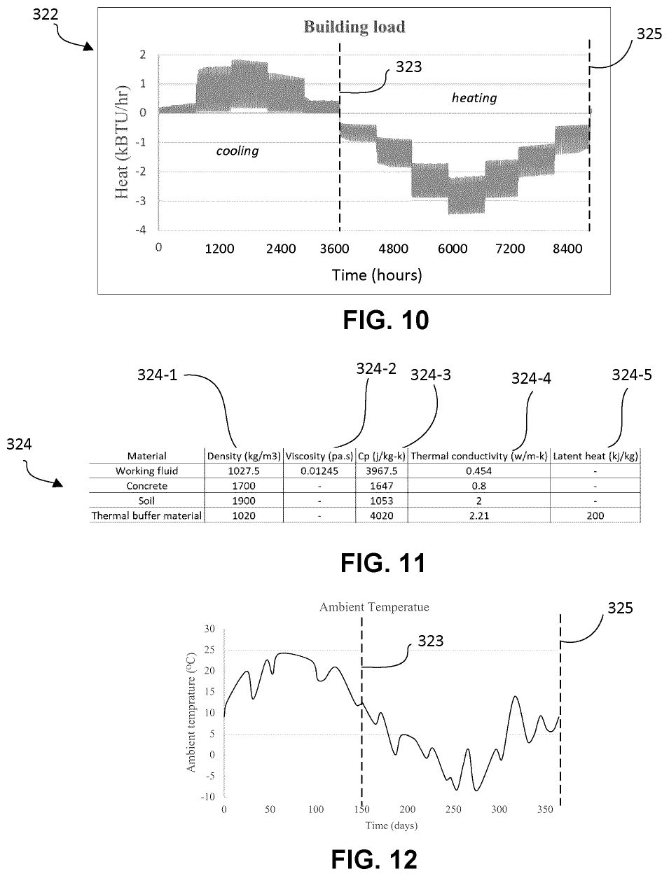

Thermal load model 322 represents thermal requirements of building 106. Thermal load model 322 includes a definition of an amount of heat input and heat extraction required by building 102 throughout a calendar year. The definition may, for example, be a table containing requirements in specific time increments. FIG. 10 shows an example thermal load model 322, comprising heat load of building 106 in hourly increments over a one-year period. In other embodiments, thermal load model may define loads in smaller increments (e.g. minutes) or larger increments (e.g. days or weeks). Generally, smaller increments of thermal load are associated with increased accuracy, albeit at increased computational cost.

Typically, thermal load model 322 defines a heating season and a cooling season within the calendar year. The cooling season corresponds to the portion of the year when heat is to be removed from the building, shown in FIG. 10 as positive building load. The heating season corresponds to the portion of the year when heat is to be added to the building, shown in FIG. 10 as negative building loads. A heating transition 323 is defined at a point in the calendar year when building loads shift from cooling loads to heating loads. A cooling transition 325 is defined as a point in the calendar year when building loads shift from heating loads to cooling loads. The example of FIG. 9 is representative of a typical building in southern Ontario, Canada. Time “zero” corresponds to early May. Heating transition 323 is approximately 3600 hours or 150 days later, corresponding to early October. Cooling transition 325 is approximately 215 days later, corresponding to the end of April. Buildings at sites in other climates may have different lengths of heating and cooling seasons, and may have transitions at different times in the calendar year.

Thermal load model 322 is also configured to simulate the temperature of working fluid entering and exiting heat pump 102. In an example, heat gained (or lost) by the working fluid in heat pump 102 is estimated as follows:

$${Q}_{R} = ( 1 - \frac{1}{COP} ) {Q}_{Building} \qquad ( 1 a )$$

$${Q}_{R} = ( 1 + \frac{1}{COP} ) {Q}_{Building} \qquad ( 1 b )$$

Where Q_{R} is the total heat gained (or lost) by the working fluid and Q_{Building} is the total heat input to or removed from the building.

The temperature increase through the pump can then be estimated as follows:

$$Δ T = \frac{{Q}_{R}}{\dot{m} Cp} \qquad ( 2 )$$

Where m is the mass flow rate of working fluid through loop 108 and Cp is the specific heat capacity of the working fluid.

Thermal properties model 324 contains values representing characteristics of the working fluid within loop 108, the thermal caisson 212 and the surrounding ground. FIG. 11 shows an example thermal properties model 324. As depicted, thermal properties model 324 includes fields 324-1, 324-2, 324-3, 324-4 and 324-5, defining density, viscosity, specific heat capacity, thermal conductivity and latent heat of fusion values, respectively. Thermal properties are recorded for each material that is part of the thermal caisson and its surroundings. For example, the thermal properties model 324 depicted in FIG. 10 includes values for working fluid, concrete, soil and thermal buffer material. As shown, some thermal properties may be absent from model 324 for some materials. For example, concrete and soil are not expected to be in a flowable state therefore, viscosity values are omitted. Similarly, only the thermal buffer material is expected to change states and therefore latent heat of fusion is specified only for the thermal buffer material.

Spatial mesh 320 may have associated values identifying which material occupies each cell of the mesh and thus, thermal properties associated with each cell, such as heat capacity, conductivity and the like.

In an example, the working fluid within loop 108 may be a mixture of water and propylene glycol, with propylene glycol at a concentration of 25% by volume. Properties of the thermal buffer material are discussed in greater detail below.

Referring again to FIG. 9, ambient temperature model 326 is a characterization of expected ambient air temperature at the geographical location where thermal caisson 212 is to be installed. Model 326 includes a defined ambient air temperature at a sequence of time steps over a one-year period. Ambient temperatures may for example be defined hourly or daily and may be drawn from historical records for the relevant geographical location. FIG. 11 shows an example plot of temperature values in ambient temperature model 326.

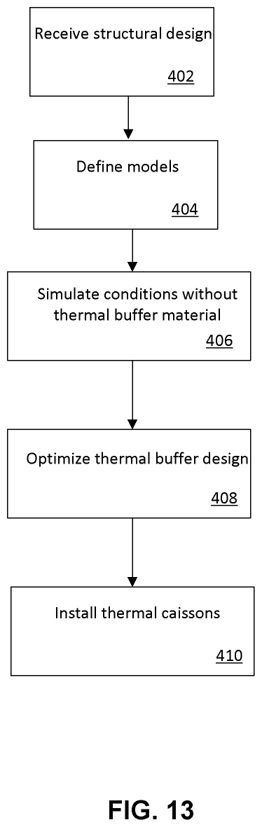

FIG. 13 depicts a process 400 of defining a thermal buffer material.

At block 402, a preliminary design of a thermal caisson 212 is received. The preliminary design includes dimensions based on building structural requirements. For example, the depth and diameter of the thermal caisson, and the number of caissons within a specific region of ground are defined based on the size and design of the building and structural characteristics of the surrounding soil.

At block 404, each of spatial mesh 320, thermal load model 322, thermal properties model 324 and ambient temperature model are defined.

As noted, spatial mesh 320 may be defined automatically. For example, mesh boundaries may be defined corresponding to material boundaries within thermal caisson 212. That is, metallic structures such as casing 214 and rebar cage 215 may be divided from concrete regions within the caisson. Likewise, loop 208 and thermal buffer 228 may be divided from one another and from the concrete and metallic regions.

Each discrete region of the spatial mesh 320 may then be divided into a grid of cells based on a desired cell size. The cells may be, for example, tetrahedral or hexahedral cells.

Thermal load model 322 is defined using step-wise approximations of building heating and cooling over a one-year period. Such approximations may be made based on computing any fixed requirements such requirements for refrigeration or industrial processes, and computing variable requirements based on building size, occupancy, intended use and local climate variation. The thermal load model 322 may be generated using energy modeling software such as EQuest™, EnergyPlus™ or Trace™.

Thermal properties of relevant materials are input to thermal properties model 324 based on known or accepted values for the materials. An initial simulation is performed for a caisson lacking phase change material in the thermal buffer 228. Accordingly, cells within thermal buffer 228 are initially assigned material values corresponding to concrete.

Ambient temperature model 326 is populated, e.g. using historical data for the geographical location at which thermal caisson 212 is to be installed.

At block 406, a simulation is performed using spatial mesh 320, thermal load model 322 and thermal properties model 324.

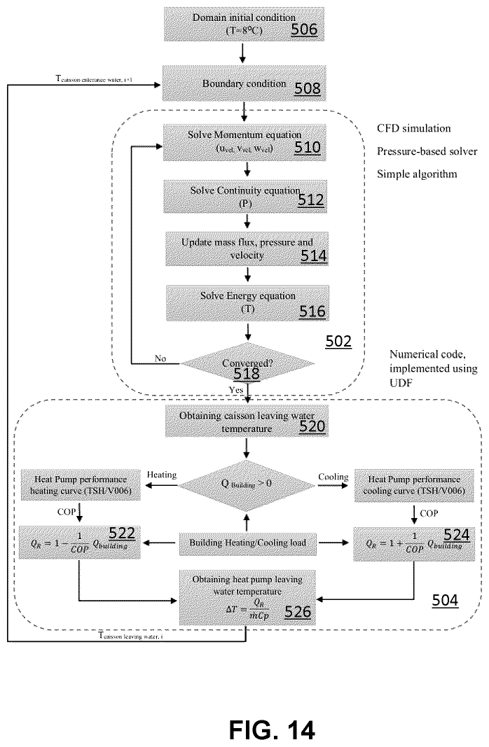

FIG. 14 depicts an example simulation process 500. Simulation process 500 includes a caisson simulation 502 and a heat pump computation 504. In the depicted example, caisson simulation 502 is performed using a finite-volume numerical method, e.g. as implemented in ANSYS Fluent™ 18.0. Heat pump computation 504 is performed analytically.

Simulation is performed in a series of time steps. The number of time steps depends on the period desired to be simulated.

At block 506, each cell within the simulation domain, i.e., each cell within spatial mesh 320, is set to an initial temperature condition, based on local ground temperature at the building site. In the depicted example, the initial temperature condition is 8° celsius.

At block 508, boundary conditions are set for the caisson simulation 502. Boundary conditions include a temperature and flow rate of working fluid entering heat exchange loop 208, a constant pressure at the outlet of heat exchange loop 208, and a temperature at the interface between the ground and air. In the depicted example, working fluid flow rate is 1 GPM. However, the flow rate may vary, based on specifications of the heat pump with which thermal caisson 212 is to be used. Fluid temperature entering heat exchange loop 208 is the same as the pump exit fluid temperature computed using heat pump computation 504 at the previous time step. At the first time step, the temperature of working fluid entering loop 208 is initialized to the same temperature as the rest of the simulation domain, i.e. 8° Celsius. Temperature at the interface between ground and air is based on values in the ambient temperatures model 326.

Once boundary conditions have been set, the resulting conditions are simulated. Computations in caisson simulation 502 are performed on a cell-by-cell basis. That his, each of the referenced equations is solved at each individual cell within spatial mesh 320, and the process is iterated until the results satisfy a convergence test.

At block 510, a momentum balance is solved. The momentum balance is computed according to the following equation:

$$\frac{\partial }{\partial t} ( ρ \vec{v} ) + ∇ \cdot ( ρ \vec{v} \vec{v} ) = - ∇ p + ∇ \cdot \{ \overline{\overline{τ}} \} + ρ \vec{g} + \vec{F} \qquad ( 3 )$$

Where ρ represents density, \vec{v} represents velocity, ρ represents static pressure, is the stress tensor, ρg is the gravitational body force and \vec{F} is the external body force. The stress tensor is defined by the following equation:

$$τ = μ [ ( ∇ \vec{v} + ∇ {\vec{v}}^{T} \} - \frac{2}{3} ∇ \cdot \vec{v} I ] \qquad ( 4 )$$

Where μ is molecular viscosity, I is the unit tensor and

$$\frac{2}{3} ∇ \cdot \vec{v} I$$

is the effect of volume dilation.

At block 512, a mass balance is solved, according to conservation of mass:

$$\frac{\partial ρ}{\partial t} + ∇ . ( ρ \vec{V} ) = 0 \qquad ( 5 )$$

Where ρ represents density and \vec{v} represents velocity.

At block 514, mass flux, pressure and density values are obtained at each cell in spatial mesh 320 according to the results obtained at blocks 510 and 512.

At block 516, a temperature is computed for each cell according to the fluid-domain energy equation:

$$\frac{\partial }{\partial t} ( ρ E ) + ∇ \cdot ( \vec{v} ( ρ E + p ) ) = ∇ \cdot ( {k}_{eff} ∇ T - {\sum }_{J} {h}_{j} {\vec{J}}_{j} + ( {\overline{\overline{τ}}}_{eff} \cdot \vec{v} ) ) + {S}_{h} \qquad ( 6 )$$

Where ρ represents density, \vec{v} represents velocity, p represents static pressure, is the stress tensor, k_{eff} is the thermal conductivity, Jⱼ is the diffusion flux of species j and Sₕ is a volumetric heat source. E is given by:

$$E = h - \frac{p}{ρ} + \frac{{v}^{2}}{2} \qquad ( 7 )$$

Where h is sensible enthalpy, defined for incompressible flows as:

$$h = {\sum }_{j} {Y}_{j} {h}_{j} + \frac{p}{ρ} \qquad ( 8 )$$

$${h}_{j} = {\int }_{{T}_{ref}}^{T} {c}_{p , j} dT \qquad ( 9 )$$

Where Yⱼ is the mass fraction of species j.

The enthalpy of the material is computed as the sum of sensible enthalpy and latent heat ΔH.

In cases where thermal buffer material is present and phase change material therein is solidifying or melting, latent heat is defined as follows:

ΔH=βL (10)

Where L is the latent heat of the phase change material and β is the liquid fraction, defined as:

$$\begin{matrix}β = 0 & if T < {T}_{solidus} \\ β = 1 & if T > {T}_{liquidus} \\ β = \frac{T - {T}_{solidus}}{{T}_{liquidus} - {T}_{solidus}} & if {T}_{solidus} < T < {T}_{liquidus}\end{matrix} \qquad ( 11 )$$

For cells in which no liquid is present, the energy equation simplifies to:

$$\frac{\partial }{\partial t} ( ρ h ) + ∇ \cdot ( \vec{v} ρ h ) = ∇ \cdot ( k ∇ T ) + {S}_{h} \qquad ( 12 )$$

At block 518, a check is performed to determine if the simulation result is converged. The result is said to have converged if, for each cell within mesh 320, the results obtained at blocks 510, 512, 516 are the same, within a specified precision. In an example, the convergence criteria is 10⁻⁷. If the convergence criteria is not met, the process iteratively repeats from block 510. If the convergence criteria is met, a corresponding heat pump computation 504 is performed.

At block 520, the temperature of working fluid exiting loop 208 calculated at block 516 is taken as the temperature of working fluid entering the heat pump. The building heating or cooling requirements, Q_{building}, for the appropriate time step are obtained from thermal load model 322.

Building heating or cooling requirements are adjusted based on a heat pump coefficient of performance, COP. The adjusted values reflect the amount of heat that is transferred to or from working fluid in the heat pump.

Building heating requirements are adjusted at block 522 according to equation 1a:

$${Q}_{R} = ( 1 - \frac{1}{COP} ) {Q}_{Building} \qquad ( 1 a )$$

The coefficient of performance, COP is less than 1. Accordingly, for Q_{building}>0, Q_{R} is a negative value with absolute value greater than that of Q_{building}, indicating that heat is transferred out of the working fluid as it passes through the heat pump.

Building cooling requirements are adjusted at block 524 according to equation 1b:

$${Q}_{R} = ( 1 + \frac{1}{COP} ) {Q}_{Building} \qquad ( 1 b )$$

Accordingly, for Q_{building}>0, Q_{R} is a positive value with absolute value greater than that of Q_{building}, indicating that heat is transferred into the working fluid as it passes through the heat pump.

At block 526, working fluid temperature change through the heat pump is computed based on the computer value of Q_{R}:

$$Δ T = \frac{{Q}_{R}}{\dot{m} Cp} \qquad ( 13 )$$

Where \dot{m} is the mass flow rate of working fluid, and Cₚ is the specific heat capacity of the working fluid.

For Q_{R}>0, working fluid temperature increases through the heat pump. For Q_{R}<0, working fluid temperature decreases through the heat pump.

After computation of a heat pump fluid exit temperature, the simulation returns to block 508 for the next time step and the computed head pump fluid exit temperature is taken as the fluid temperature at the inlet to loop 208 at the next time step.

Referring again to FIG. 13, after simulation is completed for a caisson lacking thermal buffer material, the thermal buffer is designed based on the simulation results.

For each time step of the simulation, an average temperature is computed at the boundary between caisson 212 and the surrounding ground. That is, a temperature is obtained at every cell at the boundary between caisson 212 and the surrounding ground, and those temperatures are averaged. The resulting value may be referred to as the average ground interface temperature.

FIG. 14 is an example plot of average ground interface temperature 600 at each time step within a one-year period of a simulation based on thermal load model 322 depicted in FIG. 9, representative of a building at a site in southern Ontario, Canada.

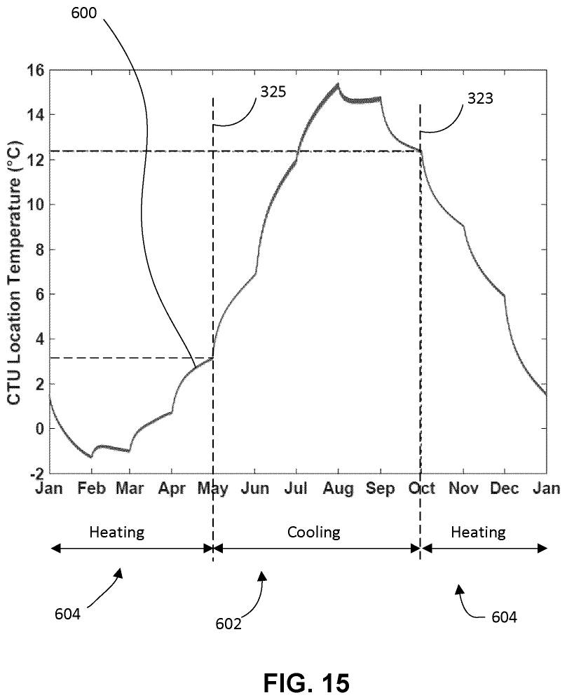

As depicted in FIG. 15, during the cooling season (from cooling transition 325 to heating transition 323, i.e. May to the end of September), heat is transferred from working fluid in loop 208 to the surrounding. During the cooling season (from heating transition 323 to cooling transition 325, i.e. October to the end of April), heat is absorbed from the surroundings by working fluid in loop 208.

During the cooling season 602, the average ground interface temperature is generally increases. During the heating season 604, the average ground interface temperature generally decreases.

Phase change material within thermal buffer 228 moderates changes to ground temperature by changing state. Specifically, melting of the phase change material allows for heat to be absorbed from loop 208 without increasing ground temperature and solidification of the phase change material allows for heat to be transferred to loop 208 without decreasing ground temperature.

The moderating effect of the thermal buffer 228 during the cooling season may be maximized when phase change material within the thermal buffer 228 is available to absorb heat by melting throughout the cooling season. The moderating effect during the heating season may be maximized when phase change material within the thermal buffer 228 is available to release heat by solidifying throughout the heating season.

For performance during the heating season, thermal buffer 228 may be designed so that it contains phase change material with a melting point corresponding to the simulated average ground interface temperature at heating transition 323, i.e. the end of the cooling season. In the example of FIG. 15, the simulated average ground interface temperature at heating transition 323 is approximately 12° C. A phase change material with this melting point would be expected to be mostly or fully in a liquid state at the end of the cooling season. The phase change material could therefore be considered to be “charged” with heat at the end of the cooling season, so that the heat is available to be extracted over the heating season.

Conversely, for performance during the cooling season, thermal buffer 228 may be designed so that it contains phase change material with a solidification point corresponding to the simulated average ground interface temperature at cooling transition 323, i.e. the end of the heating season. In the example of FIG. 15, the simulated average ground interface temperature at cooling transition 325 is approximately 3° C. A phase change material with this solidification temperature would be expected to be mostly or fully in a solid state at the end of the heating season. The phase change material could therefore be considered to be “charged” for cooling, so that it is available to extract heat from working fluid over the cooling season.

Many applications require balancing of the performance benefit associated with thermal buffer 228 with its cost, which depends heavily on the quantity of phase change material added. Accordingly, thermal buffer 228 may be configured for a specific performance criterion, namely performance optimization during a heating mode or performance optimization during a cooling mode.

Performance during heating may be prioritized in buildings with larger cumulative thermal loads for heating than for cooling (referred to as heating-dominant buildings). Performance during cooling may be prioritized in buildings with larger cumulative thermal loads for cooling than for heating (referred to as cooling-dominant buildings).

In the depicted example, a thermal buffer 228 having phase change material with melting point of approximately 12° C. reflects heating-dominant performance prioritization for a building sited in southern Ontario, Canada, or another geographical location with similar climate and ground temperatures. a thermal buffer 228 having phase change material with melting point of approximately 3° C. reflects cooling-dominant performance prioritization for a building sited in southern Ontario, Canada, or another geographical location with similar climate and ground temperatures.

In some applications, it may be desired to prioritize performance in both cooling and heating modes, in spite of high cost of installation. In such cases, multiple different phase change materials may be added. For example, a first phase change material having a melting point based on ground temperature at heating transition 323, and a second phase change material having a solidification point based on ground temperature at cooling transition 325, may both be added.

As will be apparent, optimal phase change temperatures may vary for buildings sited in different climates. However, a thermal buffer 328 with a phase change material having a melting point based on ground temperatures at heating transition 323 will generally represent a good balance of cost and performance in a heating mode, and a thermal buffer 328 with a phase change material having a solidification point based on ground temperatures at cooling transition 325 will generally represent a good balance of cost and performance in a cooling mode.

Optionally, simulation process 500 may be repeated after design of thermal buffer 228. In such cases, material properties of the thermal buffer may be included, so that the simulation results reflect anticipated performance of a caisson 212 with a thermal buffer 228.

In some embodiments, multiple candidate thermal buffer designs may be identified, for example, having melting points higher than and lower than the melting point selected as described above. Simulated results for each candidate may be compared, and the candidate that produces the lowest variation of ground interface temperature throughout a one-year period may be selected.

Referring again to FIG. 13, at block 410, once the properties of thermal buffer 228 have been defined, thermal caisson 212 may be installed.

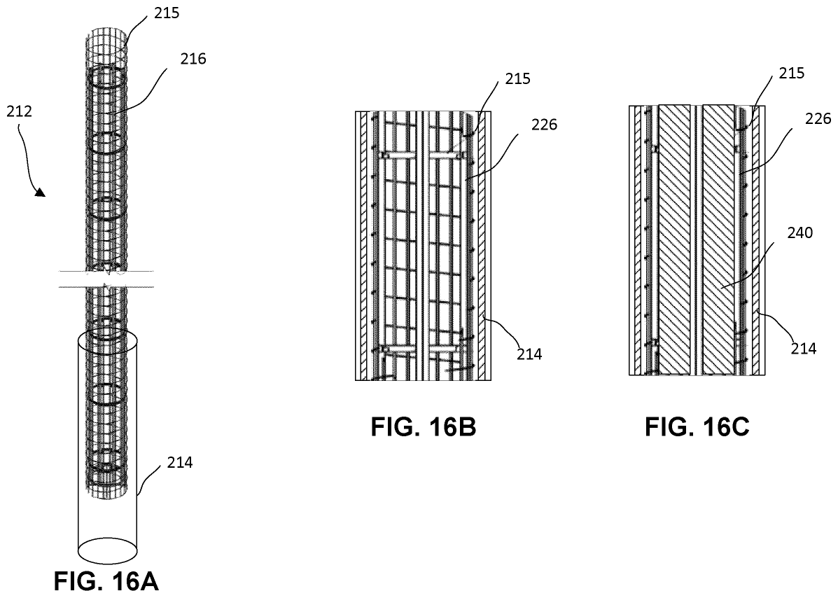

FIGS. 16A-16C depict stages of installation of caisson 212.

As shown in FIG. 16A, the structure of caisson is partially assembled above-ground. In particular, as shown, rebar cage 215 is assembled and mounted to casing 214. Fluid conduits 216 defining loop 208 are assembled and mounted to casing 214, and jackets 226 are positioned around conduits 216 to define thermal buffers 228. Phase change material is installed within the thermal buffers.

As shown in FIG. 16B, a hole is bored at a location and depth corresponding to the design of caisson 212 and the assembled caisson structure is inserted into the hole.

As shown in FIG. 16C, concrete 240 is poured into casing 214 of caisson 212. The concrete encases rebar cage 215 and jackets 226 within which thermal buffers 228 and fluid conduits 216 are positioned. Fluid conduits 216 can be connected to a building heat pump once the heat pump is installed.

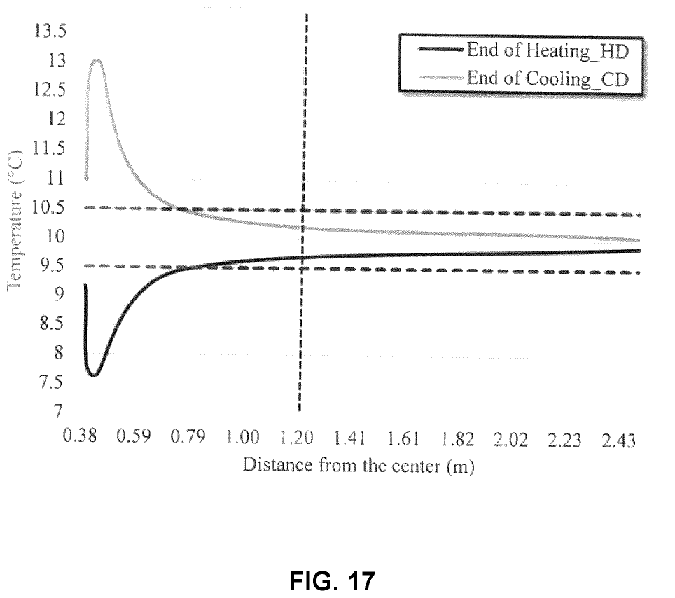

In some embodiments, multiple thermal caissons 212, 212′, 212″, 212′″, 212″″ may be installed in the ground at a spacing selected to limit thermal interaction of the caissons with one another. For example, FIG. 17 depicts a representative plot of ground temperature versus distance from the center of the heat exchange loop in heating and cooling modes. In the depicted example, for soil having density of 1900 kg/m3, thermal conductivity of 2 W/mK, specific heat of 1053 J/kgK and a far-field temperature of 10° C., the ground temperature at a distance of 1 m from the heat exchange loop is within ±0.5° C. of the far-field temperature. Accordingly, a caisson center-to-center spacing of at least 2 m may limit thermal effects of caissons on one another. For applications with larger thermal loads, or locations with ground having lower specific heat, lower density or higher thermal conductivity, this spacing may be larger. Conversely, for lower thermal loads and higher specific heat, higher density or lower thermal conductivity, this spacing may be smaller.

Of course, the above described embodiments are intended to be illustrative only and in no way limiting. The described embodiments are susceptible to many modifications of form, arrangement of parts, details and order of operation. The invention is intended to encompass all such modification within its scope, as defined by the claims.

1. A system for heating and cooling a building, comprising:
a structural foundation member extending into a borehole;
a heat exchange loop within said foundation member and interconnected with a heat pump for providing heating or cooling to said building by heat exchange with ground surrounding the foundation member.

2. The system of claim 1, further comprising a phase change material within said structural foundation member to absorb heat from or reject heat to fluid in said heat exchange loop.

3. The system of claim 2, wherein said phase change material has a melting point corresponding to a simulated annual maximum ground temperature.

4. The system of claim 2, wherein said phase change material is contained in a space surrounding a pipe of said heat exchange loop.

5. The system of claim 4, wherein said phase change material is contained in a pipe surrounding said pipe of said heat exchange loop.

6. The system of claim 2, wherein said phase change material is contained in a pipe spaced apart from said heat exchange loop.

7. The system of claim 2, comprising phase change material interposed between hot and cold legs of a heat exchange loop.

8. The system of claim 1, wherein said structural foundation member is a piling.

9. The system of claim 1, wherein said structural foundation member is a caisson.

10. The system of claim 1, wherein said structural foundation member comprises a rebar cage, and wherein said heat exchange loop is positioned within said rebar cage.

11. The system of claim 1, wherein said foundation member comprises poured concrete.

12. The system of claim 11, wherein said poured concrete comprises an additive to increase thermal conductivity.

13. The system of claim 1, comprising a plurality of said structural foundation members each having a heat exchange loop, wherein a spacing between said structural foundation members is at least 2 metres.

14. A method of installing a ground-source heat exchange loop in thermal communication with a heat pump of a building, the method comprising:
boring a hole in ground for receiving a structural foundation member;
placing a ground-source heat exchange loop within said hole.

15. The method of claim 14, further comprising placing a phase change material into said hole.

16. The method of claim 15, wherein said phase change material is selected to have a melting point corresponding to a temperature characteristic of said ground.

17. The method of claim 16, comprising selecting said melting point by simulating annual ground temperatures proximate said hole.

18. The method of claim 17, wherein simulating annual ground temperatures comprises defining a thermal numerical model of said ground source heat exchange loop.

19. The method of claim 18, wherein simulating annual ground temperatures comprises modelling annual ground temperatures proximate said hole in the absence of said phase change material.

20. The method of claim 19, wherein said phase change material is selected to have a melting point corresponding to a simulated ground temperature at the beginning of a heating season for said building.

21. The method of claim 14, comprising pouring concrete into said structural foundation member.

22. The method of claim 21, wherein said concrete comprises an additive to increase thermal conductivity.

23. A thermal design system, comprising:
a finite-volume model of a below-ground foundation structure of a building with a heat exchange loop therein;
a thermal requirements model defining heating and cooling requirements of a building in discrete time steps over a one-year period;
a simulator configured to compute ground temperatures according to said thermal model based on said heating and cooling requirements;
a thermal reservoir unit, configured to define a phase change reservoir for installation in a below-ground foundation structure, wherein defining a phase change reservoir comprises defining a phase change temperature based on a ground temperature corresponding to a transition between heating and cooling requirements in said model.
